(19) United States
(12) Patent Application Publication
(10) Pub. No.: US 2004/0241029 A1
(43) Pub. Date: Dec. 2, 2004

(54) Parallel rotating piston engine with side walls

(76) Inventor: Manfred Max Rapp, Hamburg (DE)

Correspondence Address: RANKIN, HILL, PORTER & CLARK LLP, 4080 ERIE STREET, WILLOUGHBY, OH, 44094-7836, US

(21) Appl. No.: 10/488,575

(22) PCT Filed: Aug. 29, 2002
(86) PCT No.: PCT/EP02/09616

(30) Foreign Application Priority Data
Sep. 5, 2001 (DE) 10143648.3

(51) Int. Cl. F03C 2/00; F04C 18/00

(52) U.S. Cl. 418/59; 418/144

(57) ABSTRACT

A piston engine including casing (1, 3, 4, 5) and a parallel-rotating piston (8). The piston is supported on the crank pin (7) of a crankshaft (2) and is secured in rotation relative to said pin (7), piston (8) is fitted with an outer wall that, when viewed in a plane perpendicular to the crankshaft axis, is partly convex (9) and partly concave (10). The outer wall is opposite a casing peripheral wall that, when viewed in the perpendicular plane, is partly concave (11) and partly convex (12). The piston outer wall and casing peripheral wall subtend a chamber (13) that opens, closes and changes its enclosed volume during parallel rotation. The chamber (13) is bounded by axially spaced side walls (14) whereby, one of the side walls (14) is affixed to the piston (8) and overlaps in sliding manner a boundary wall (3′) which is perpendicular to the axis and which is part of the compartment (3) that subtends the peripheral wall (11, 12) and is part of the casing (1, 3, 4, 5). The other side wall (14′) is affixed to the compartment (3) and slidingly overlaps a boundary wall (8′) of the piston (8), with the piston boundary wall (8′) being perpendicular to the axis.

### BACKGROUND OF THE INVENTION

A piston engine of the above kind is known from WO 93/25801. As explained therein, the engine may be used as an expansion/compression engine, a pump and also illustratively as an internal combustion engine comprising one or more chambers.

In the known design, the sealing taking place in the axial direction of the crankshaft of the piston's boundary surfaces is implemented relative to two parallel chamber side walls which are subtended by the casing. However such a design entails certain drawbacks.

If the piston engine is used as an internal combustion engine or as a compressor, substantial heat will be generated in the chamber, and part of such heat also must be dissipated through the piston which thereby is highly stressed thermally. In the process the crankshaft and the bearings will be thermally stressed. Heat drainage from the piston constitutes a substantial problem which is aggravated by the piston being enclosed between the stationary side walls.

The respective patents DE 37 16 017 and U.S. Pat. No. 1,378,065 disclose similar parallel-rotating piston engines wherein, unlike the above known design, the piston runs on stationary side walls but where lateral surfaces affixed to the piston will run in sealing manner on stationary casing parts. The latter design offers the advantage that the piston no longer is thermally trapped between stationary side walls. Instead the co-moving side walls act as moving cooling surfaces which in fact cool the piston well. In this manner the thermal stresses on piston and crankshaft bearings are reduced.

These two designs employing side walls affixed to the piston and moving jointly with it incur the drawback that both side walls are rigidly connected by the piston to each other. If there is thermal warping, the side walls may jam.

### SUMMARY OF THE PRESENT INVENTION

The objective of the present invention is to reduce thermal problems, while precluding the danger of jamming, in piston engines of the above type.

In the present invention, the piston moves on one side on a stationary side wall and comprises on its other side a side wall that moves jointly with it. The considerable advantages of the second design cited above are attained thereby, namely good piston cooling due to the co-moving side wall. However the danger of jamming present in the known designs is avoided because only one co-moving side wall is present on only one side. Accordingly, jointly with its co-moving side wall, the piston is able to be spaced laterally from the stationary side wall, consequently side wall jamming will be averted in case of thermal deformations. A further advantage of this design is that the engine of the present invention may be made destruction-proof for those cases when ordinarily a gas shall be compressed but sometimes an incompressible liquid is sucked in. In that event the attempt to compress the liquid would destroy the engine. If on the other hand the piston and the compartment, each fitted with a side walls affixed to them, may laterally move out of the way, the piston illustratively moving out of the way against a restoring spring, such destruction shall be precluded.

The piston is advantageously supported to allow axial adjustment relative to the compartment. Accordingly, by being axially displaced out of one position, and the side walls being in sliding overlap, the piston may be moved into another position wherein the side walls will overlap while a gap is subtended. This gap may be enlarged or reduced. In this manner a targeted leakage in the piston engine chamber may be set. This feature is advantageous for instance when the engine is used as a compressor. Therefore, at idle or at starting speed, a large gap—namely substantial leakage—may be set to reduce power absorption at idle. The air flowing through the gaps created will provide additional cooling.

Regarding the above design, an angle subtended with the horizontal may be advantageously implemented by the configuration of both the piston outer wall and the compartment's peripheral wall, so that when adjusting the piston relative to the compartment, that is by parallel-adjustment of the surfaces, the spacing between the latter shall be changed. When the angle to the horizontal is very small, and the piston is axially adjusted, the spacing between the piston's outer wall and the compartment's peripheral wall may be adjusted very finely. In this manner the gap between the outer wall and peripheral wall may be adjusted very finely at those lines where they run on each other. In this manner manufacturing inaccuracies and illustratively thermal expansions may be compensated for and a very narrow line gap may be set which nevertheless shall preclude contact between the surface.

When the side walls overlap while being elastically sealed off, the piston may be slightly adjusted axially relative to the compartment without thereby incurring lateral leakages because same are balanced by the elastic seal. In this manner the gap at the contact line between the outer and peripheral walls may be set without incurring leakages in the chamber.

In this design, if the adjustment is too narrow, contact will take place between the peripheral and outer walls in the vicinity of the edges of the two oblique surfaces, the gap being subtended at that side wall which is affixed to the compartment, that in the vicinity of the stationary wall. This feature allows affixing, in a controlled manner, a contact sensor in the vicinity of the side wall, for instance the compartment's peripheral wall. This sensor allows measurement of the gap to the piston's outer wall. If this gap should become unduly small, then the axial adjustment of the piston may be corrected correspondingly. Preferably, such a sensor shall be configured at the wall's hottest spot, namely in the vicinity of the outlet valve.

### BRIEF DESCRIPTION OF THE FIGURES

FIG. 1 is an axial elevation of a piston engine of the invention shown along the section of line 1-1 of FIG. 2,

FIG. 2 is an axial section along line 2-2 in FIG. 1, and

FIG. 3 is a section corresponding to FIG. 2 of another embodiment mode of the piston engine of the present invention.

### DETAILED DESCRIPTION OF PREFERRED AND ALTERNATE EMBODIMENTS

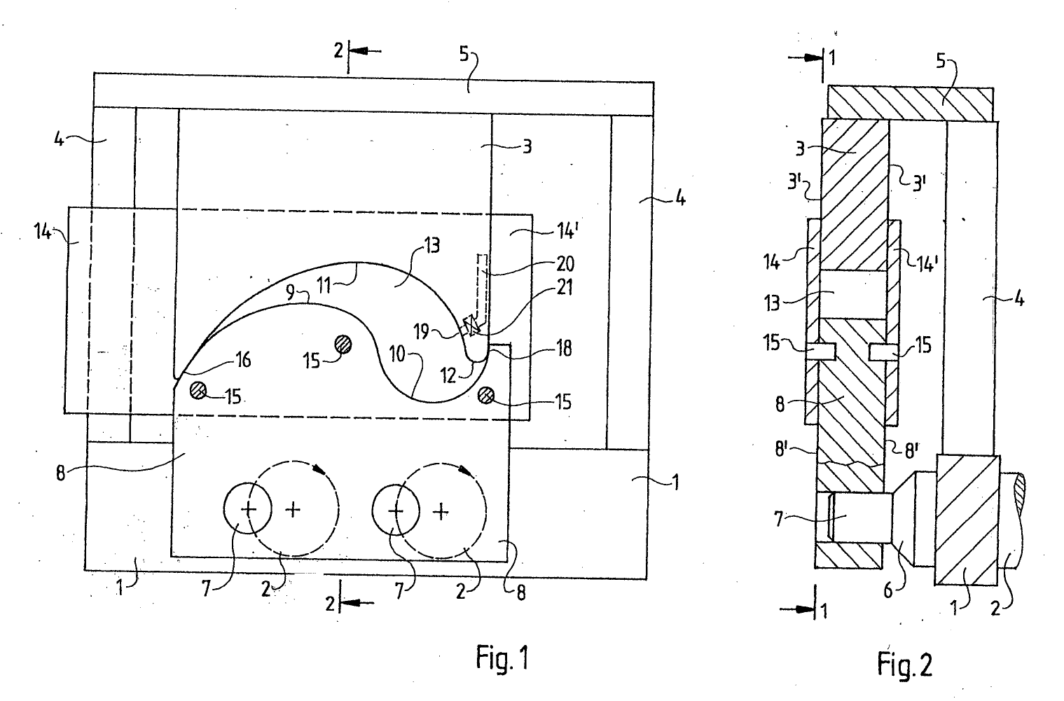

As shown by FIGS. 1 and 2, the piston engine comprises a casing consisting of a crank bearing block 1 supporting in it two crankshafts 2 and a compartment 3 rigidly connected by means of casing segments 4 and 5 to the crank bearing block 1.

The crankshafts 2 each subtend crank pins 7 linked by bends 6 and supported in a piston 8. Angularly synchronized rotation of the axes of the crank pins 7—as indicated in dashed arrows in FIG. 1—results in the parallel rotation cited in WO 93/25801 that should be consulted for details of that piston engine design. In order to constrain angular synchronization of the two crankshafts 2, a synchronized transmission (not shown) may be used. More than two crankshafts may be used to attain improved piston stability during parallel rotation and to eliminate a synchronized transmission between the crankshafts. One of the several crankshafts may serve as power train or as a power output while the other shall run in idle to only constrain parallel rotation.

As shown in FIG. 2, both the piston 8 and the casing compartment 3 exhibit the same length in the direction of the axis of the crankshaft 2, the piston 8 comprising boundary walls 8′ and the compartment 3 comprising boundary walls 3′, the walls 8′ and 3′ being mutually aligned on each side.

At its outer wall facing the compartment 3, the piston 8 subtends convex and concave wall surfaces 9, 10. At its peripheral wall facing the piston, the compartment 3 subtends concave and convex wall surfaces 11, 12. For parallel rotation of the piston 8, the wall surfaces 9, 10 move in a sliding manner on the wall surfaces 11, 12 and constitute a chamber 13 which, as seen in the axial direction, is sealed end-wise by parallel side walls 14, 14′.

The side walls 14, 14′ are affixed to the piston 8 and overlap the boundary faces 3′ of the compartment 3. The side walls slide by their surfaces on the boundary faces when the piston is in parallel rotation, and they seal the chamber 13.

The side walls 14, 14′ may be integral with the piston 8. In the illustrative embodiment shown, and especially as shown in FIG. 2, the side faces are in the form of separate, flat plates resting against the end faces 8′ of the piston 8 to which they are affixed by screws 15.

When the piston 8 is in parallel rotation and the crank pin 7 rotates clockwise, then, in the shown angular position, the chamber 13 is just sealing at site 16 between the wall surfaces 9 and 11 and at the other end at the site 18 between the wall surfaces 10 and 12. As the piston 8 continues rotating, the wall surfaces 9 and 11 advantageously run at a slight gap between and in sealing manner, and so do the wall surfaces 10 and 12. The chamber 13 continuously decreases its volume as far as in the vicinity of the site 19, which is fitted with an exhaust duct 20 comprising an outwardly opening check valve 21. Illustratively, the shown engine may be used as a compressor driven by one of the crankshafts 2.

When, relative to the shown position, and after about 180° rotation of the crankshaft, the smallest volume of the chamber 13 has been attained, the chamber will reopen as the crankshafts continue rotating, and as a result fresh air for venting and cooling may flow at the sites 16 and 18 from both chamber ends.

The shown side walls 14, 14′ may be fitted on their outsides with cooling fins to improve piston cooling.

The shown design, and only with minor alterations, is also applicable to all piston engine embodiment modes disclosed in WO 93/25801. The piston engine of the present invention may be used for all applications disclosed in WO 93/25801.

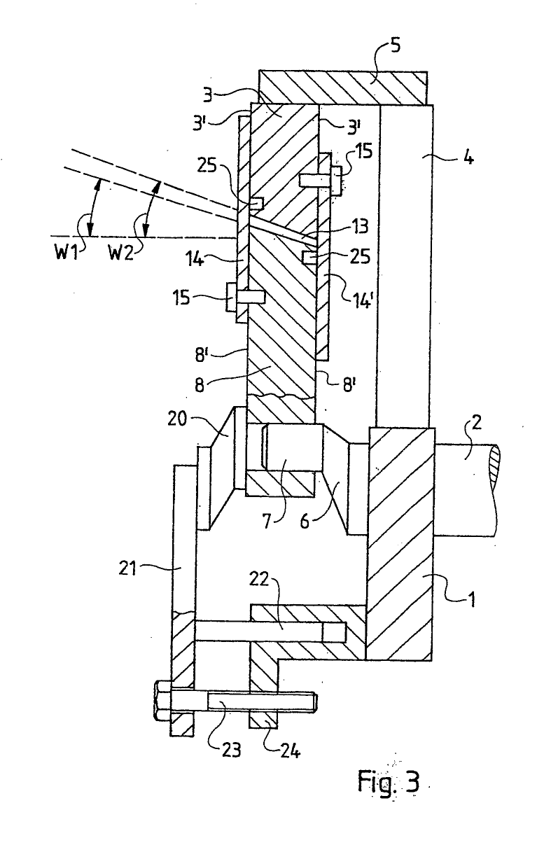

FIG. 3 shows another embodiment of the piston engine sectionally shown in FIG. 2. To the extent possible, the same references symbols are used.

In this latter embodiment, one side wall, namely 14, is affixed at the piston 8 exactly as it is in the embodiment of FIG. 2. The other side wall 14′, which is situated toward the casing 4, is affixed to the compartment 3 correspondingly. Accordingly, the piston 8 together with its side wall 14 is displaceable, relative to the compartment 3 and to its side wall 14′, to the left in the axial direction of the crankshaft 2, that is away from the casing 4, whereupon the side walls 14, 14′ shall detach while subtending a gap from the boundary walls 8′ and 3′ on which they are meant to slide in overlapping manner. In this manner the chamber 13 shall communicate with the outside through the gaps subtended in this manner.

In the embodiment mode of FIG. 3, the piston 8 is shown somewhat phase-shifted relative to the position shown in FIGS. 1 and 2. The crankshaft 2 of FIG. 3 did continue rotating by about 90° relative to the position shown in FIG. 1 and as a result the line contact at the site 16 in FIG. 1 between the chamber walls 9 and 11 now is substantially situated in the sectional line shown in FIG. 3. At that site the chamber 13 now subtends a narrow linear gap (shown enlarged for clarity) that seals the chamber 13.

As shown in FIG. 3, the outer wall consisting of the segments 9 and 10 of the piston 8 as well as the peripheral wall consisting of segments 11 and 12 of the compartment 3 subtend respectively angles W1 and W2 to the horizontal. In this manner the gap shown in FIG. 3 between the piston 8 and the compartment 3 may be enlarged by displacing the piston 8 relative to the compartment 3 in the axial direction of the crankshaft 2.

The angles to the horizontal W1 and W2 preferably and as shown in FIG. 3 shall be different, namely the angle W2 at the peripheral wall of the compartment 3 is larger than the angle W1 subtended at the piston outer wall. As a result the edges of the outer wall and the peripheral wall are closer together near the side wall 14′ than are the other edges at the side wall 14. If there is contact between the peripheral and outer walls, then it shall take place at the edges situated at the side wall 14′.

At those sites, sensors (omitted from the drawing) are mounted in the peripheral wall of the compartment 3 and measure the gap between the outer wall and the piston 8.

The angles to the horizontal, namely W1 of the outer wall of the piston 8 and W2 of the peripheral wall of the compartment 3 each are configured beyond the walls in a manner that the outer wall and the peripheral wall are conical. Accordingly the outer wall segments 11 and 12 of the peripheral wall of the compartment 3 and the wall segments 9 and 10 of the outer wall of the piston 8 each are conical.

To axially displace in a controlled manner the piston 8 relative to the compartment 3, the piston 8 is supported on its side opposite the crankshaft 2 with an articulation 20 which, illustratively and as indicated in the embodiment, consists of two thrust bearings configured on one hand concentrically with the crank pin 7 and on the other hand concentrically with the crankshaft 2. This bearing system 20 rests on a casing segment 21, which is displaceable in the direction of the axis of the crankshaft 2 relative to the shaft's bearing block 1. The casing segment 21 is displaceable by a slide guide 22 in the direction of the axis of the crankshaft 2 and is adjustable using a screw 23 which, as shown, is retained in rotatable manner in the casing segment 21 and which can be screwed into a threaded protrusion 24 of the crank bearing block 1. When resetting the screw 23, the piston 8 is drawn in the direction of the axis 2 against the crank bearing block 1, or released. The piston need not being actively reset in the direction away from the crank bearing block 1, that is, in FIG. 3, toward the left, because the pressure in the chamber 13 always biases it toward the left, that is away from the crank bearing block 1.

By adjusting the screw 23, the gap between the side walls 14 and 14′ can be adjusted, so that the gap of the chamber 13 shown in FIG. 3 may be enlarged or reduced.

In an alternative to the embodiment of FIG. 3, the piston 8 also may be kept in place and it is the chamber 3 that is axially readjusted relative to the casing 4, 5.

In an alternative to the above embodiment modes, the side wall 14 also may be affixed to the compartment 3 and the side wall 14′ to the piston 8. In that case, to implement axial displacement, the piston of FIG. 3 would have to be adjusted to the right, toward the casing segment 4.

Instead of the adjusting screw 23 shown in FIG. 3, a stepping motor may be used which, illustratively, is electrically driven by an appropriate control device as a function of engine parameters such as engine temperatures, angular speed and the like for the illustrative purpose of optimizing the gap between the peripheral and outer walls by compensating for thermal expansion, or of axially displacing the piston 8 at the idling angular speed until the side walls have detached. The above-noted distance sensor between the outer and peripheral walls may be used to control the motor. A further sensor to control the stepping motor may be configured, for instance between the piston 8 and the side wall 14′.

In order that the sealing of the chamber at the side walls 14 and 14′ be mechanically continuous, the walls are fitted with elastic linear seals 25. The linear seals 25 may be in the form of grooves running parallel to the substantially S-shaped edges of the piston 8 and of the compartment 3, as indicated in FIG. 3. An elastic sealing material may be mounted into the grooves, or resilient sealing strips may be configured in them that shall provide sealing ability over a given adjustment path of the piston 8 due to adjusting the screw 23. If the screw 23 is unscrewed even further, the piston 8 will lift excessively to the left in FIG. 3 and, as a result, the elastic seals 25 lift off the side walls 14 and 14′, whereby the chamber 13 now communicates with the outside for the purpose of reducing the engine's idle power absorption.

Regarding the embodiment of FIG. 3, the slide guide 22 between the piston 8 and the compartment 3 may be fitted with an additional overload safety device in the form of a spring (not shown) which, in the presence of excessive pressures in the direction of the slide guide in the chamber 13, shall allow the piston 8 to move out of the way laterally. Such a relief system may be advantageous if, for instance, water, which on account of its incompressibility then entailing engine destruction, should be erroneously sucked in during air compression. In such an eventuality the piston would be able to get laterally out of the way and avert such destruction.

1. A piston engine comprising a casing (1, 3, 4, 5) and a piston (8), said piston rests on a crank pin (7) of a crankshaft (2) and is secured against angular change relative to said pin and rotates in parallel with said pin, where said piston is fitted with an outer wall that, when viewed in a plane perpendicular to an axis of the crankshaft, is partly convex-shaped (9) and partly concave-shaped (10), said outer wall being opposite a casing wall that, when viewed in said perpendicular plane, is partly concave-shaped (11) and partly convex-shaped (12), where said piston outer wall and said casing wall subtend a volume-variable chamber (13) that opens and closes during parallel rotation, said chamber (13) being bounded by axially-apart side walls (14), wherein one of the side walls (14) is affixed to the piston (8) and in sliding manner overlaps a boundary wall (3′) of a compartment (3) of the casing (1, 3, 4, 5) while the other side wall (14′) is affixed to the compartment (3) and slidingly overlaps a boundary wall (8′) of the piston (8), said piston boundary wall (8′) being configured perpendicularly to said axis.

2. The piston engine as claimed in claim 1, wherein the side wall (14) affixed to the piston (8) is configured as a plane plate affixed to the boundary walls (3′) of the piston (8).

3. The piston engine as claimed in claim 1, wherein the piston (8) is supported in axially adjustable manner relative to the compartment (3).

4. The piston engine as claimed in claim 3, wherein the outer wall (9,10) of the piston (8) and the peripheral wall (11, 12) of the compartment (3) conically subtend an angle (W1, W2) relative to a line that is parallel to said axis.

5. The piston engine as claimed in claim 4, wherein the side walls (14, 14′) are elastically sealed during their sliding overlap.

6. The piston engine as claimed in claim 4, wherein the angles (W1, W2) differ only so little that the peripheral wall (11, 12) and the outer wall (9, 10) exhibit a lesser gap at their edges situated at the side wall (14′) affixed to the compartment (3) than at the opposite edges.
